(19) United States
(12) Patent Application Publication
(10) Pub. No.: US 2008/0262827 A1
(43) Pub. Date: Oct. 23, 2008

(54) Real-Time Translation Of Text, Voice And Ideograms

(75) Inventor: Ben DeGroot, Los Angeles, CA (US)

Correspondence Address: PERKINS COIE LLP, P.O. BOX 1208, SEATTLE, WA, 98111-1208, US

(73) Assignee: Telestic LLC

(21) Appl. No.: 11/874,371

(22) Filed: Oct. 18, 2007

Related U.S. Application Data
(63) Continuation-in-part of application No. 11/691,472, filed on Mar. 26, 2007.

(51) Int. Cl. G06F 17/28; G06F 17/20; G10L 21/00

(52) U.S. Cl. 704/3; 704/8; 704/4; 704/277; 706/11; 704/E13.011

(57) ABSTRACT

A system and method translate a statement in real time. Artificial intelligence translates text, speech or ideograms from a first language to a second language. The translated statement may be edited by a person at the source of the message and/or a person receiving the statement. Edits are used to train the artificial intelligence in the proper translation of the language. The system learns the language, or a vernacular thereof, and translates future messages in accordance with the edits received.

### RELATED APPLICATIONS

This application is a continuation-in-part and claims priority to U.S. patent application Ser. No. 11/691,472, filed Mar. 26, 2007, and entitled “ACCURATE INSTANT MESSAGE TRANSLATION IN REAL TIME” by Ben DeGroot, Giancarlo Tallarico., which is incorporated by reference.

### BACKGROUND

Embodiments of the inventions are illustrated in the figures. However, the embodiments and figures are illustrative rather than limiting; they provide examples of the inventions.

Communication between users of different languages requires real time translation. Otherwise communications will suffer from delay. In one context, text is a medium for communication. As such, instant messaging, email, SMS instant messages, and other forms of text based communication require instant translation to maintain conversations. In another context, the translation of voice requires real-time results for users of one language to speak with users of another language in real-time. In yet another context, some languages communicate in pictograms, or ideograms, such as Chinese, Japanese, and Korean. In this regard, translation between languages of ideograms requires real-time results for individuals to communicate well. However, there has not been created a system or method that can, in real-time, translated communications across a variety of forms of communication.

Further, an issue is the training of an artificial intelligence system to translate a language. It is possible for individuals of disparate geographic locations, backgrounds, education levels, and other factors to communicate in different vernaculars where each uses the same language. Translation in a language that does not account for differences in vernaculars is in inadequate because some individuals may desire that the translations “sound right,” or otherwise operate in accordance with a vernacular of a language that the individual uses.

The foregoing examples of the related art and limitations related therewith are intended to be illustrative and not exclusive. Other limitations of the related art will be come apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above described problems have been reduced or eliminated, while other embodiments are directed to other improvements.

A technique based on artificial intelligence captures a language by observing the changes that individuals make to messages as they are translated. Artificial intelligence is trained on the language by messages that are spoken or typed. Edits are collected and used to train in the translation of a vernacular. The artificial intelligence learns the language and future translations reflect the edits received. A system translates text, voice, pictogram and/or ideograms between languages based on the artificial intelligence.

### BRIEF DESCRIPTION OF THE DRAWINGS

Embodiments of the inventions are illustrated in the figures. However, the embodiments and figures are illustrative rather than limiting; they provide examples of the inventions.

FIG. 1 shows an exemplary network in which an embodiment may be implemented.

FIG. 2 illustrates an example of a basic configuration for a computing device on which an embodiment may be implemented.

FIG. 3A illustrates user screens or windows on computing devices engaging in an exemplary instant message (IM) session in accordance with an embodiment.

FIG. 3B illustrates an exemplary pop-up window to facilitate the user to edit or revise a translation of the original instant message in accordance with an embodiment.

FIG. 3C illustrates an exemplary pop-up window to facilitate the user to edit or revise a translation of the responsive instant message in accordance with an embodiment.

FIG. 4 is a flow chart that generally outlines the operation of the system to translate instant messages in accordance with an embodiment.

FIG. 5 is block diagram illustrating the components and the data flow of a system in accordance with an embodiment.

FIG. 6 illustrates an exemplary implementation of IMDP in accordance with an embodiment.

FIG. 7 depicts a flowchart 700 of an example of a method for training an artificial intelligence system in translating a message.

FIG. 8 depicts a flowchart 800 of an example of a method for training an artificial intelligence system to use a vernacular of an individual.

FIG. 9 depicts a flowchart 900 of an example of a method for translating speech using an artificial intelligence system.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

In the context of a networked environment, general reference will also be made to real-time communication between a “source” device and a “destination” device. The term device includes any type of computing apparatus, such as a PC, laptop, handheld device, telephone, mobile telephone, router or server that is capable of sending and receiving messages over a network according to a standard network protocol.

Source computing devices refer to the device that initiates the communication, or that first composes and sends a message, while destination computing devices refer to the device that receives the message. Those skilled in the art will recognize that the operation of the source computing device and destination computing device are interchangeable. Thus, a destination computing device may at some point during a session act as a sender of messages, and a source computing device can at times act as the recipient of messages. For this reason, the systems and methods of the invention may be embodied in traditional source computing devices as well as destination computing devices, regardless of their respective hardware, software or network configurations. Indeed, the systems and methods of the invention may be practiced in a variety of environments that require or desire the performance enhancements provided by the invention. These enhancements are set forth in greater detail in subsequent paragraphs.

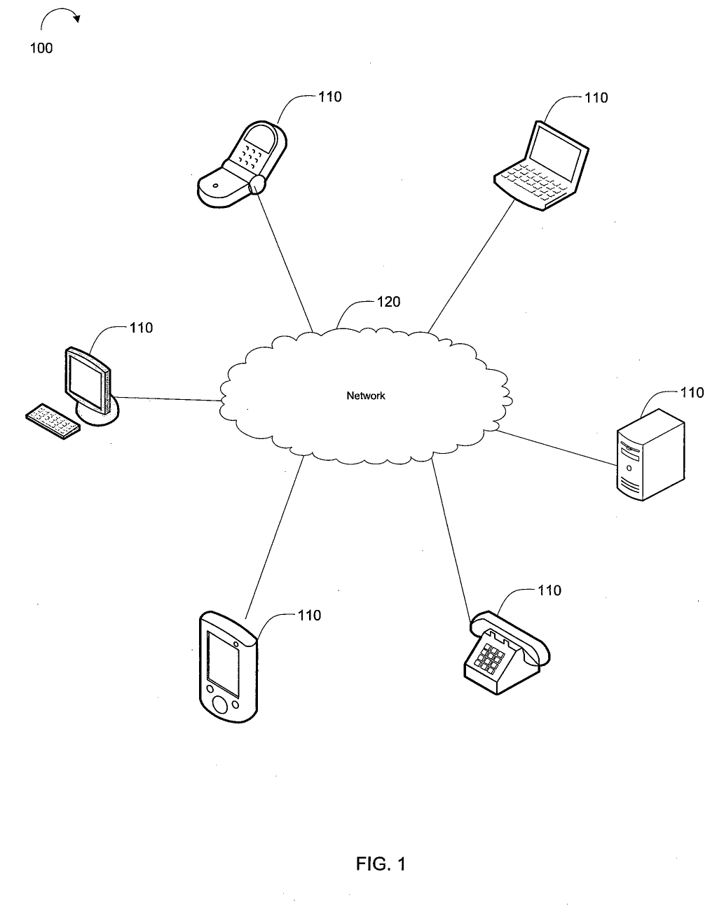

FIG. 1 shows an exemplary network 100 in which an embodiment may be implemented. The exemplary network 100 includes several communication devices 110 communicating with one another over a network 120, such as the Internet, as represented by a cloud. Network 120 may include many well known components (such as routers, gateways, hubs, etc.) to allow the communication devices 110 to communicate via wired and/or wireless media.

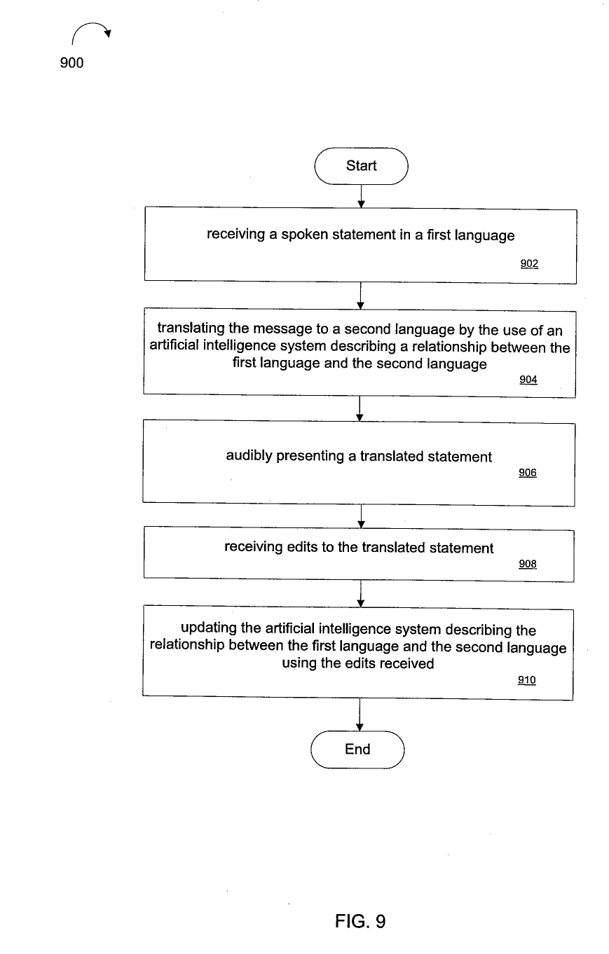

In some embodiments, text based messaging is used to communicate between users. However, speech, pictogram and ideogram communication is contemplated as well. By using voice to text and text to voice, the system can receive spoken language and process it as text. For example, an individual could speak the word “hello” and the word “hello” would be recognized. That word “hello” could then be translated to ideograms such as [symbol] in Mandarin. Then a text to speech processor could produce the related sound “Ni Hao.” The resulting sound could be delivered as speech. Speech translation is discussed in more detail in regard to FIG. 9.

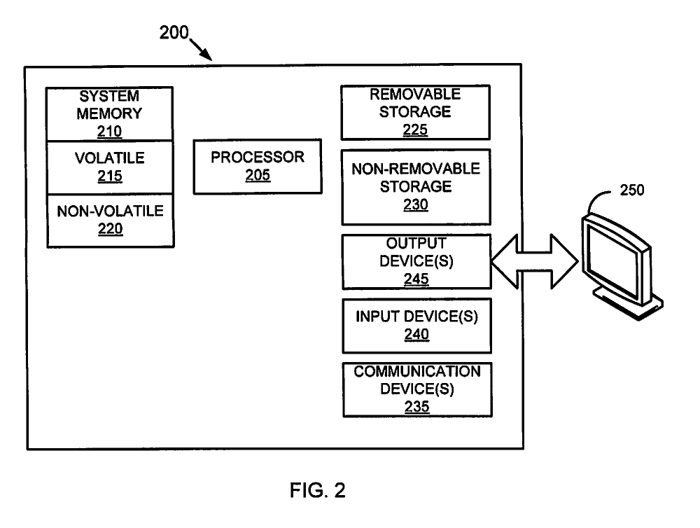

FIG. 2 illustrates an example of a basic configuration for a computing device 200 on which an embodiment may be implemented. Computing device 200 typically includes at least one processing unit 205 and memory 210. Depending on the exact configuration and type of the computing device 200, the memory 210 may be volatile (such as RAM) 215, non-volatile (such as ROM or flash memory) 220 or some combination of the two. Additionally, computing device 200 may also have additional features/functionality. For example, computing device 200 may also include additional storage (removable 225 and/or non-removable 230) including, but not limited to, magnetic or optical disks or tape. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to stored the desired information and which can be accessed by computing device 200. Any such computer storage media may be part of computing device 200.

Computing device 200 may also contain one or more communication devices 235 that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media, connection oriented and connectionless transport. The term computer readable media as used herein includes both storage media and communication media.

Computing device 200 may also have one or more input devices 240 such as a keyboard, mouse, pen, voice input device, touch input device, etc. Output devices 240 such as a display 250, speakers, a printer, etc. may also be included. All these devices are well known in the art and need not be discussed at length here.

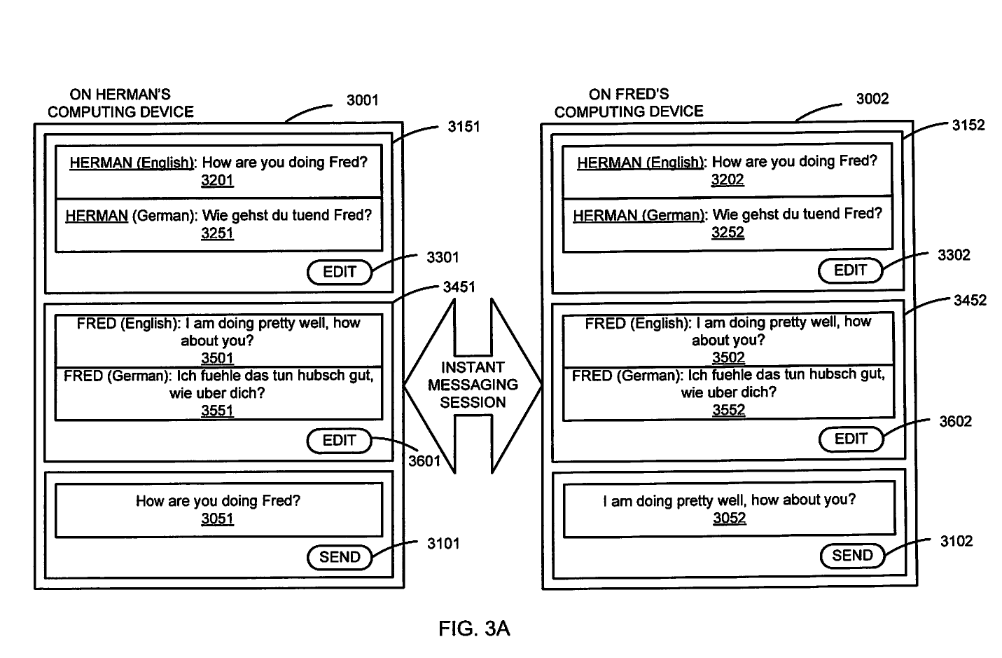

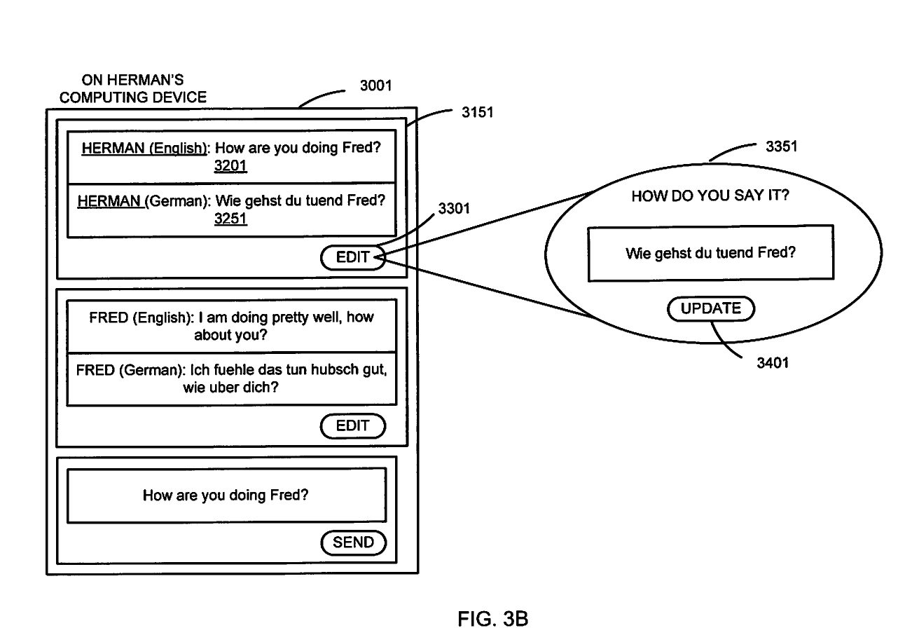

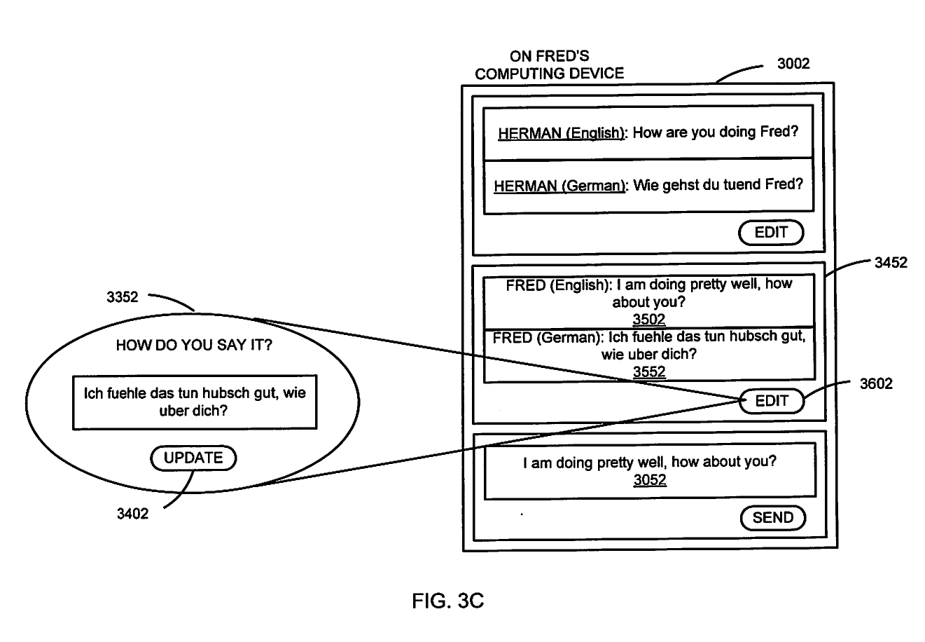

FIG. 3A illustrates user screens or windows on computing devices engaging in an exemplary instant message (IM) session in accordance with an embodiment. For the purposes of illustrating an example, the languages used in the exemplary IM session of FIG. 3A are English and German. In practice, any languages could be used. As shown FIG. 3A, each user screen or window 3001 and 3002 appears on the user's respective computing device. Each user screen 3001 and 3002 includes a message composition window (or screen) 3051 and 3052 for the user to compose the instant message, and a “SEND” button 3101 and 3102 that the user would activate to submit or send the instant message upon completion of composition.

Furthermore, each user window or screen includes a display message window (or screen) 3151 and 3152 to display the instant message composed and sent by a first user (e.g., HERMAN as shown in FIG. 3A). The display message window (or screen) 3151 and 3152 includes an original display message window (or screen) 3201 and 3202 for displaying the message in its original language, and a translated display message window (or screen) 3251 and 3252 for displaying the message in another language. As shown in FIG. 3A, the original display message window is used to display the message in English (the source language), and the translated display message window is used to display the message in German (the destination language). Furthermore, there is an “EDIT” button 3301 and 3302 situated below the translated display message window. The user would activate this “EDIT” button 3301 and 3302 to revise the translated display message.

As shown in FIG. 3B, when the user activates the “EDIT” button 3301, a pop-up window (or screen) 3351 would appear. If the user wishes to revise the translated display message, he or she would do so in the pop-up window (or screen), and would push or activate the “UPDATE” button 3401. By activating the “UPDATE” button 3401, the user effectively submits his or her revisions or edits of the translation of the display message. Returning to FIG. 3A, the user window includes a responsive message window (or screen) 3451 and 3452 to display the instant message that composed by a second user (FRED as shown in FIG. 3A) in response to the first user's instant message. The response message window (or screen) includes an original response message window (or screen) 3501 and 3502 for the displaying the response message in its original language, and a translated response message window (or screen) 3551 and 3552 for displaying the response message in another language. As seen in FIG. 3A, the original response message window is used to display the message in English (the source language), and the translated response message window is used to display the response message in German (the destination language). Furthermore, there is an “EDIT” button 3601 and 3602 situated below the translated response message window. The user would activate this “EDIT” button 3601 and 3602 to revise the translated response message.

As shown in FIG. 3C, when the user activates the “EDIT” button 3602, a pop-up window (or screen) 3352 would appear. If the user wishes to revise the translated response message, he or she would do so in the pop-up window (or screen) 3352, and would push or activate the “UPDATE” button 3402. By activating the “UPDATE” button 3402, the user effectively submits his or her revisions or edits of the translation of the response message.

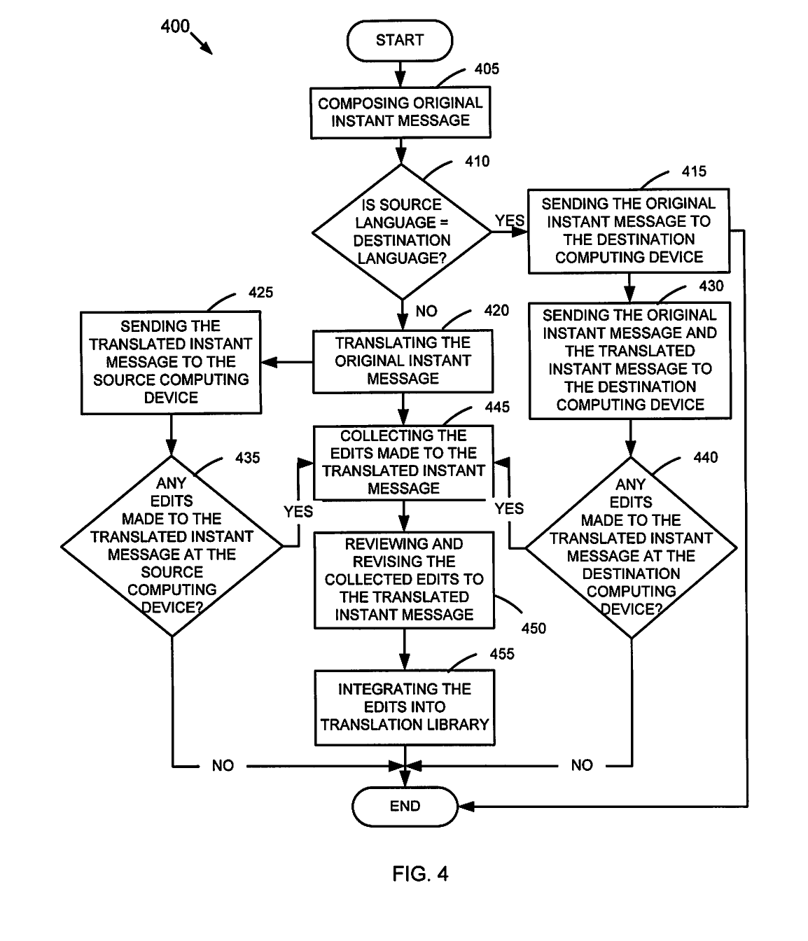

FIG. 4 is a flow chart 400 that generally outlines the operation of the system to translate instant messages in accordance with an embodiment. In block 405, an instant message is composed using an original source language. In block 410, a determination is made as to whether the source language is the same as the destination language. If yes, the original instant message is sent to the destination computing device (see block 415). If the source language is not the same as the destination language, the original instant message is translated (see block 420). As will be described below in more detail, the translation will be performed by an Artificial Intelligence (AI) based translation server or engine with a neural network that is initially trained with language translation training files, and that is continually refined with user inputs (such as edits or revisions to translated instant messages from actual users or from linguists). The artificial intelligence system could be based on other than neural networks; e.g. a genetics algorithm could be employed. Furthermore, the translation could be performed in a language context selected based on statistical weights, such as a profile weight (assigned based on the profile of the user) and/or a convolution weight (assigned based on certain parameters derived from the user inputs such as the frequency of the inputs, or the repetitions or duplicates of the same edits or revisions for the original instant message).

Once the original instant message has been translated, the translated message is sent to the source computing device (see block 425). At the source computing device, the translated instant message is displayed on the device's screen (as shown, for example, in FIGS. 3A and 3B, and described above). Upon reviewing the translated instant message, the user has the opportunity to edit or revise the translation.

In addition, the original instant message and the translated instant message are sent to the destination computing device (see block 430). At the destination computer device, the original instant message and the translated instant message are displayed on the device's screen (as shown, for example, in FIGS. 3A and 3C, and described above). At the destination computing device, the user has opportunity to edit or revise the translation.

If edits or revisions are made to the translated instant message (see blocks 435 and 440), these edits or revisions would be collected (see block 445). As will be discussed below in more detail, the collection of submitted edits or revisions would be performed at the edits server. Furthermore, the collected edits or revisions to the translated message are reviewed and possibly revised. In one embodiment or implementation of the invention, trained linguists would review and revise the collected edits and revisions to the translated instant message (see block 450).

In block 455, the edits or revisions to the translated instant message are integrated into the translation data base. As will be discussed below in more detail, in an embodiment, the edits or revisions to the translated instant message are collected and saved and periodically sent to the translation server or engine as update(s) to the translation library.

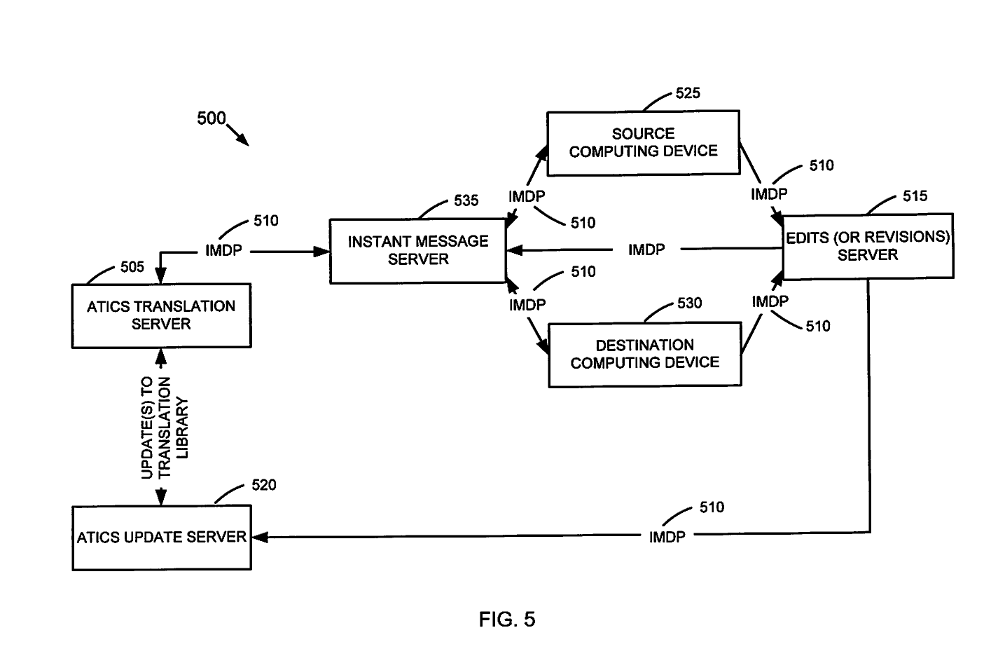

FIG. 5 is block diagram 500 illustrating the components and the data flow of a system in accordance with an embodiment. In general, this system facilitates the automatic translation of instant messages generated from two separate devices (a source computing device and a destination computing device). Furthermore, once the translated instant message is displayed at the source computing device and the destination computing device, users at these devices could edit and revise the translated instant message. The system would collect and store these edits and revisions (i.e., user inputs or contributions), and would later use these user inputs or contributions (similar to an open source environment). As one example of usage, the system could use the user inputs or contributions to train the AI-based translation engine or server 505. As another example of usage, the system could assigned a weight (referred to as the convolution weight) based on certain parameters derived from the inputs or contributions (such as the frequency of the inputs, or the repetitions or duplicates of the same edits or revisions for the original instant message), and use the assigned weight to select a particular vernacular used in a particular context (such as a formal language context, a slang language context, an age-group-based language context, a sport-centric language context, a language context commonly used at a particular time period—e.g., the 50's, the 60's, the 70's, the 80's, the 90's). Generally, a vernacular is defined as a plain variety of language in everyday use by a group of ordinary people.

In one embodiment, as shown in FIG. 5, the Instant Message Data Packet (IMDP) 510 is used to facilitate communication among the components in the system. However, as stated above, the invention is not limited to any one instant messaging service or network protocol. More specifically, the invention could be implemented within any instant messaging services or networks that facilitate real-time communication, including, but is not limited to, AOL Instant Messenger (AIM), Jabber, ICQ (“I seek you”), Windows Live Messenger, Yahoo! Messenger, GoogleTalk, Gadu-Gadu, Skype, Ebuddy, ICQ, .NET Messenger Service, Paltalk, iChat, Qnext, Meetro, Trillian, and Rediff Bol Instant Messenger. Furthermore, in these instant messaging services or networks, sessions are executed according to network protocols designed to enhance and support instant messaging. Such protocols include, but are not limited to, OSCAR (used, for example, in AIM and ICQ), IRC, MSNP (used, for example in MSN Instant Messenger), TOC and TOC2 (used, for example, in AIM), YMSG (used, for example, in Yahoo! Messenger), XMPP (used, for example, in Jabber), Gadu-Gadu, Cspace, Meca Network, PSYC (Protocol for Synchronous Conferencing), SIP/SIMPLE, and Skype. In general, the system of FIG. 5 would be capable of translating an IMDP to a traditional instant message packet (and vice versa) in accordance with one of the protocols listed above and any other similar protocols.

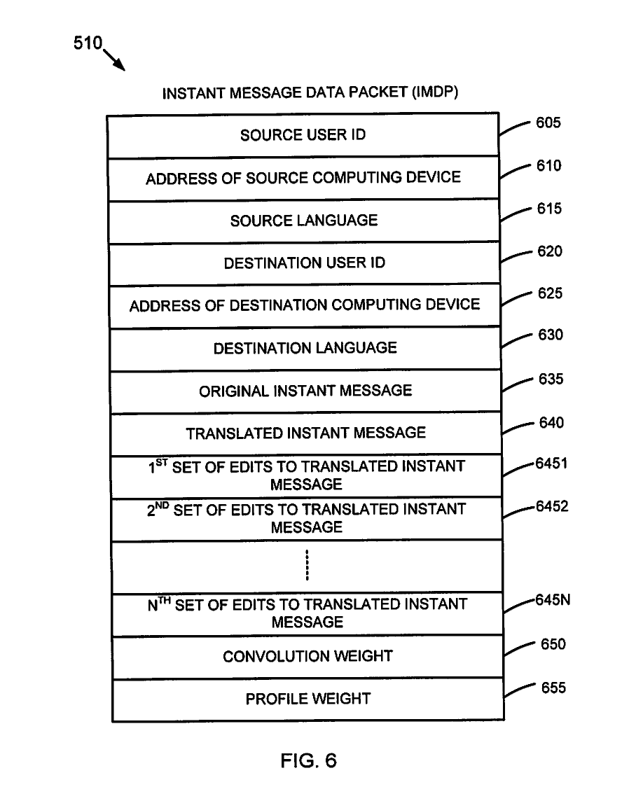

FIG. 6 illustrates an exemplary implementation of IMDP 510 in accordance with an embodiment. As shown in FIG. 6, the IMDP includes several fields of information. As a general principle of operation, each field of information of the IMDP would be filled in by a component in the system, to the extent possible at particular instances in time, to facilitate communication.

More specifically, the IMDP 510 includes information fields related to the source, including a source user id (or identification) 605, an address of the source computing device 610, and the source language 615. The source user id 605 field contains sufficient information to identify the user at the source computing device. The address of the source computing device 610 would be used to route or send instant messages to the device. The source language field 615 indicates the language that the user at the source computing device could read and would use to compose his or her instant messages.

In addition, the IMDP 510 includes information fields related to the destination, such as a destination user id (or identification) 620, and address of the destination computing device 625, and the destination language 630. The destination user id 620 field contains sufficient information to identify the user at the destination computing device. The address of the destination computing device 625 would be used to route instant messages to the device. The destination language field 630 specifies the language used at the destination computing device.

Furthermore, the IMDP 510 includes fields to contain original instant message 635, the translated instant message 640, and N (where N is a positive integer) slots 6451, 6452, . . . , 645N to store edits or revisions made to the translated instant message. The edits or revisions to the translated instant message could be entered by the users at the source computing device or the destination computing device, as well as by one or more linguists assigned to review the edits or revisions made by the users.

In one embodiment, the IMDP also includes a convolution weight 650 field and a profile weight field 655. These fields 650 and 655 are used to select a language context (such as a formal language context, a slang language context, an age-group-based language context, a language context commonly used at a particular time period—e.g., the 50's, the 60's, the 70's, the 80's, the 90's) to perform the translation. More specifically, the convolution weight is assigned based on certain parameters derived from the inputs or contributions (such as the frequency of the inputs, or the repetitions or duplicates of the same edits or revisions for the original instant message). In addition, the profile weight is assigned based on parameters derived from the user profile, such as the user's age and/or geographical location.

Returning to FIG. 5, in one embodiment, after the user at the source computing device 525 composes an original instant message, the source computing device 525 generates an IMDP 510 (containing the source user id, the address of the source computing device, the source language, the destination user id, the address of the destination computing device, and the original instant message) and sends the packet to the instant message server 535. Upon receipt of the packet, the instant message server 535 determines whether the source language is the same as the destination language. If the source language is the same as the destination language, the instant message server 535 simply forwards the packet containing the original instant message to the destination computing device. If the source language is not the same as the destination language, the instant message server 535 forwards the packet containing the original instant message to the translation server 505 for translation.

In one embodiment, to enable the translation server 505 to select a proper language context to perform the translation, the instant message server 535 would add or update the profile weight and the convolution weight of the packet that it receives from the source computing device 525 and would send the updated packet to the translation server 505. In this embodiment, the instant message server would add or update the convolution weight based on parameters relevant to the selection of a proper language context. One example of such a parameter would be the date and time during which the instant message session occurs. In this example, if the date and time indicates that the instant message occurs during working hours of a weekday, a formal (or business) language context should and would likely be selected. Furthermore, the instant message server 535 would typically add or update the profile weight of the packet based on an analysis of the profile of the user at the destination computing device 530.

The translation server 505 includes an AI-based translation engine that uses a neural network to perform the translation. Before it is operational, the neural network is trained using language training files, which is a collection of deconstructed language phrases represented using numeric values typically used in a machine translation system. Examples of different systems of machine translation that could be used to implement the invention could include, but are not limited to, inter-lingual machine translation, example-based machine translation, or statistical machine translation. To perform the translation of the original instant message, the translation server 505 would deconstruct the message into a representative numeric value consistent with the machine translation that is implemented, and use its neural network to perform the translation and to generate a translated instant message. The translation server 505 would then send the translated instant message (via an IMDP) to the instant message server 535. In one embodiment, the translated instant message could be reviewed and revised by a linguist before it is sent to the instant message server. The IMDP that is sent by the translation server 505 would be the packet that the server 505 receives plus the translated instant message added by the server 505.

Upon receipt of the IMDP containing the translated instant message and other necessary information, the instant message server 535 would re-route this packet to the source computing device 525 as well as the destination computing device 530. By re-routing the packet, the instant message server 535 is in effect sending the translated instant message to the source computing device 525, and the original instant message as well as the translated instant message to the destination computing device 530.

Upon receipt of the IMDP containing the translated instant message, the source computing device 525 and the destination computing device 535 would display the translated instant message on the respective screen of each device (as shown in FIGS. 3A, 3B, and 3C). The users at each respective device would have an opportunity to edit and revise the translated instant message. After the user at each respective device activates the “UPDATE” button (as shown in FIGS. 3B and 3C) to complete and send the edits or revisions, the edits and revisions would be stored in the edit slots in the IMDP, and the packet would be sent to the edits server 515. In one embodiment, a linguist would review and revise the user edits and revisions made to the translated instant message.

The edits server 515 would forward the edits or revisions to the translated instant message to the update server 520. The update server 520 would gather and compile the edits and revisions and would periodically send these edits and revisions to the translation server 505 as updates to the translation library. In effect, the edits and revisions would be used (as part of the translation library) in subsequent translations of subsequent original instant messages.

Furthermore, in one embodiment, the edits server would add or update the convolution weight based on a review of the edits or revisions made by the user. For example, if the edits server detects that edits or revisions were made to consistently put the instant messages in a formal language context, the server would add a convolution weight or update the existing convolution weight to steer the system toward selecting a formal (or business) language context to perform the translation.

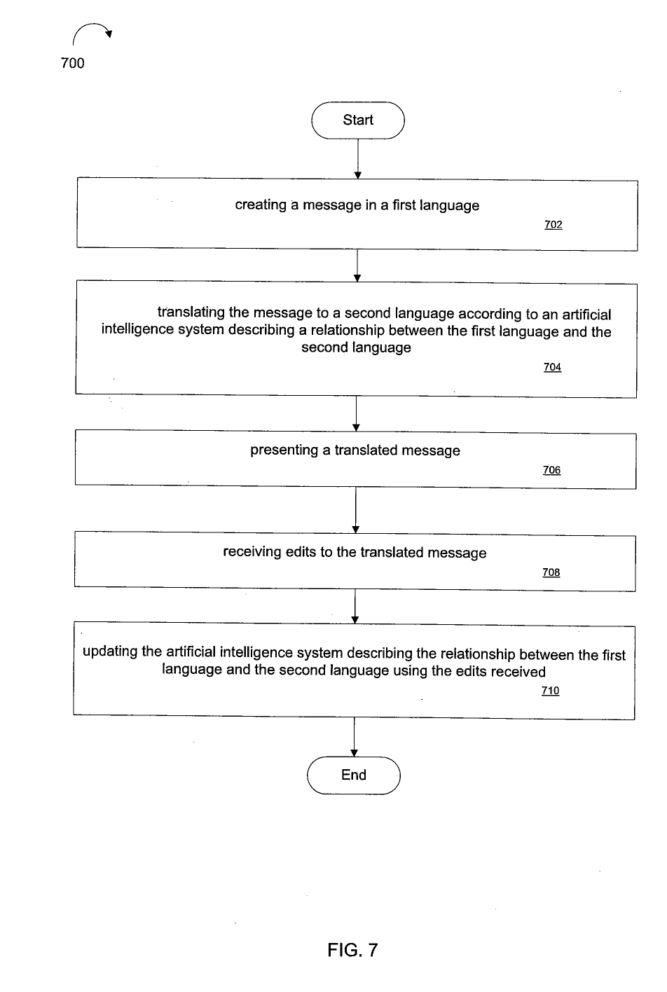

FIG. 7 depicts a flowchart 700 of an example of a method for training an artificial intelligence system in translating a message. The method is organized as a sequence of modules in the flowchart 700. However, it should be understood that these and other modules associated with other methods described herein may be reordered for parallel execution or into different sequences of modules.

In the example of FIG. 7 flowchart 700 starts at module 702 with creating a message in a first language. This message could be created as text, speech, pictogram or ideogram. Ideogram refers to any language entry utilizing pictures rather than words for a written language. In a non-limiting example, an ideogram could be Japanese, Chinese, or Korean language. Text includes any typed words. Speech includes any spoken form of communication.

In the example of FIG. 7 the flowchart continues to module 704 with translating the message to a second language according to an artificial intelligence system describing a relationship between the first language and the second language. The artificial intelligence system could be based on a neural network, or could use genetic algorithms to determine translations. The system stores a relationship between a first language and a second language as it regards text, speech, pictograms and ideograms.

In the example of FIG. 7 the flowchart continues to module 706 with presenting a translated message. The translation from the first language to the second language comprises concepts that have been expressed. Presenting the translation can be visual, audible, or both visual and audible.

In the example of FIG. 7 the flowchart continues to module 708 with receiving edits to the translated message. In the case of text or ideogram based translations, a user may edit the message directly by making changes. These edits are generally typed edits. However, in the case of speech, a user may audibly notify the system that the translation is incorrect and provide edits in the form of speech. In a non-limiting example, the individual may state, e.g., “correction” followed by a replacement statement for the translation.

In the example of FIG. 7 the flowchart continues to module 710 with updating the artificial intelligence system describing the relationship between the first language and the second language using the edits received. Once edits are received by the artificial intelligence, they are incorporated into a relationship describing the translation from the first to the second language. These edits are used in future translations.

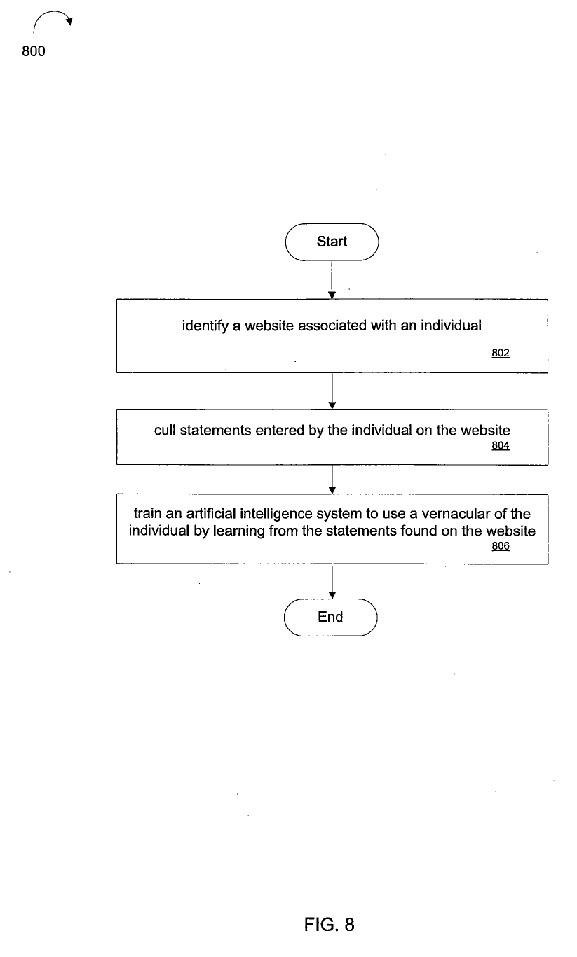

FIG. 8 depicts a flowchart 800 of an example of a method for training an artificial intelligence system to use a vernacular of an individual. The method is organized as a sequence of modules in the flowchart 800. However, it should be understood that these and other modules associated with other methods described herein may be reordered for parallel execution or into different sequences of modules.

In some embodiments, initial training of the system could be by causing the system to aggregate publicly available sources. In order to learn a particular vernacular, the system could be trained by reading publicly web sources. If an age specific vernacular was desired, age group specific blogs could be used to train the system. The aggregation of numerous web pages of information would lead to an understanding of the language. For a subject matter specific vernacular, subject matters specific websites could be used, e.g. scientific publications. In a non-limiting example, the system could be taught to learn a teenage vernacular by reading postings on a teen specific social networking website.

In the example of FIG. 8 flowchart 800 starts at module 802 with identify a website associated with an individual. Websites are rich sources of individual information. Users post their own statements, and these statements can be used to identify a vernacular. In a non-limiting example, web-crawling programs identify a user's postings and personal websites.

In the example of FIG. 8 the flowchart continues to module 804 with identifying a website associated with an individual. By reading entries the user has made on her website. Programs collect statements made by the individual.

In the example of FIG. 8 flowchart 800 starts at module 806 with training an artificial intelligence system to use a vernacular of the individual by learning from the statements found on the website. By comparing the statements made by the individual to known language sources, differences between the known language and the user's statements can be collected and stored to identify a vernacular that the individual uses.

FIG. 9 depicts a flowchart 900 of an example of a method for translating speech using an artificial intelligence system. The method is organized as a sequence of modules in the flowchart 900. However, it should be understood that these and other modules associated with other methods described herein may be reordered for parallel execution or into different sequences of modules.

In the example of FIG. 9 flowchart 900 starts at module 902 with receiving a spoken statement in a first language. In a non-limiting example a recording device is used to capture speech for a system.

In the example of FIG. 9 flowchart 900 continues to module 904 with translating the message to a second language by the use of an artificial intelligence system describing a relationship between the first language and the second language. Speech processing techniques for recognizing language are employed to identify words from the statement. In some embodiments, concepts contained in speech are translated. In some embodiments, the speech is converted to text before being translated. In such a case, the statement is in the form of a typed entry when it is translated. The translation is then reproduced as an audible statement.

In the example of FIG. 9 flowchart 900 continues to module 906 with audibly presenting a translated statement. This translation is obtained by using artificial intelligence to convert the statement.

In the example of FIG. 9 flowchart 900 continues to module 908 with receiving edits to the translated statement. In some embodiments, an individual at either a source or a destination verbally enters edits to the statement. In some embodiments the edits may be entered after alerting the system that edits are to be made. An individual could say “correction” followed by edits to the translated statement.

In the example of FIG. 9 flowchart 900 continues to module 910 with updating the artificial intelligence system describing the relationship between the first language and the second language using the edits received. The artificial intelligence system may then use the relationship between the first language and the second language including any edits made for future translations.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations, and equivalents as fall within the true spirit and scope of the present invention.

We claim:

1. A method for training a system to translate a language comprising:
creating a statement in a first language;
translating the message to a second language according to an artificial intelligence system describing a relationship between the first language and the second language;
presenting a translated statement;
receiving edits to the translated statement; and
updating the artificial intelligence system describing the relationship between the first language and the second language using the edits received.

2. The method of claim 1 wherein the statement is created as speech, text, pictograms or ideograms.

3. The method of claim 1 wherein the artificial intelligence system is based on a genetic algorithm or a neural network.

4. The method of claim 1 wherein the translated statement is presented to a first user for edits then presented to a second user for edits.

5. The method of claim 1 wherein a trained linguist provides the edits after reviewing the translated statement.

6. The method of claim 1 wherein the statement is translated according to a specific vernacular associated with an individual making the statement.

7. The method of claim 6 wherein the vernacular is determined by considering a publicly available website associated with the individual.

8. The method of claim 1 wherein the system is directed to instant messaging.

9. The method of claim 1 wherein the edits are received at a source computing device.

10. The method of claim 1 wherein the edits are received at a destination computing device.

11. An interface for training a system to translate a language comprising:
a display message window displaying a message first sent by a source user displayed in a source language;
a translated message window displaying the message in a destination language; and
an edit function to make changes to the translated message wherein the edits are saved in an artificial intelligence system storing the language including relationships between the source language and the destination language.

12. The interface of claim 11 further comprising:
an update functionality wherein the source user or a destination user submits changes to the translation of the translated message using the update functionality.

13. The interface of claim 11 wherein the update functionality causes the changes to be submitted to a computing system changing a way in which messages will be translated in the future.

14. The interface of claim 11 further comprising:
a responsive message window displaying a second message entered by the second user at the destination computer in response to the message entered the source user.

15. The interface of claim 11 further comprising:
an original response message window displaying the message composed by the source user.

16. A data structure stored in a computer readable medium for training a computing device to translate a language comprising:
a source user ID identifying a source user at a source computing device;
an address of the source computing device;
a source language used at the source computing device;
a destination user ID identifying a destination user at a destination computing device;
an address of the destination computing device;
a destination language used at the destination computing device;
an original message created at the source computing device;
a translated message received at the destination computing device; and
a first set of edits to the message made at the source computing device.

17. The data structure of claim 16 further comprising:
a second set of edits to the message made at the destination computing device.

18. The data structure of claim 16 further comprising:
a convolution weight derived from an input used to determine a language context for the translated message.

19. The data structure of claim 16 further comprising:
a profile weight derived from a user's profile.

20. The data structure of claim 19 wherein the profile weight is derived from a user's age and geographical location.

21. A method for training an artificial intelligence system to translate speech in real time comprising:
receiving a spoken statement in a first language;
translating the message to a second language by the use of an artificial intelligence system describing a relationship between the first language and the second language;
audibly presenting a translated statement;
receiving edits to the translated statement; and
updating the artificial intelligence system describing the relationship between the first language and the second language using the edits received.

22. The method of claim 21 wherein edits to a translation are verbally offered following a spoken command to take edits to the translation.

23. The method of claim 21 wherein the spoken statement is converted to text, the text is translated by the artificial intelligence system and the translated text is converted to speech, and where the edits are made by a first person at a source of the spoken statement, or the edits are made by a second person at a destination of the spoken statement after hearing the translated statement.

24. The method of claim 21 wherein translation is accomplished using a specific vernacular of a language associated with an individual making the statement.

25. The method of claim 21 wherein a no edits function is available at the source of the spoken or written statement and wherein a no edits function is available at a destination of the spoken or statement.
